(19) United States
(12) Patent Application Publication
(10) Pub. No.: US 2019/0295169 A1
(43) Pub. Date: Sep. 26, 2019

(54) INTELLIGENT TRADING AND RISK MANAGEMENT FRAMEWORK

(71) Applicant: Ziggurat Technologies, Inc., Berkeley, CA (US)

(72) Inventors: Siamak NAZARI, Berkeley, CA (US); Hassan KHANIANI, Berkeley, CA (US)

(21) Appl. No.: 16/365,631

(22) Filed: Mar. 26, 2019

Related U.S. Application Data
(60) Provisional application No. 62/648,154, filed on Mar. 26, 2018.
(60) Provisional application No. 62/701,851, filed on Jul. 23, 2018.

(51) Int. Cl. G06Q 40/04; G06F 3/01; G06T 19/00; G02B 27/01

(52) U.S. Cl. CPC G06Q 40/04; G02B 27/017; G06T 19/006; G06F 3/015

(57) ABSTRACT

A computer-implemented integrated framework for managing real-time financial trades and risk management is described herein. Quantitative and sentimental parameters of trading market are identified and analyzed. A stock selection module having a deep learning architecture performs future predictions based on the analyzed quantitative and sentimental parameters, wherein the stock selection module comprises. A probability number in percentage is assigned to a trading decision. Based on the assigned probabilities to different trading decisions, entrance and exit signals are provided to a user based on their preferences such as the user's risk tolerance.

### CROSS-REFERENCE TO RELATED APPLICATION

This application claims the benefit of U.S. Provisional Application Ser. No. 62/648,154, filed on Mar. 26, 2018, and claims the benefit of U.S. Provisional Application Ser. No. 62/701,851, filed on Jul. 23, 2018, which are herein incorporated by reference in their entireties for all purposes.

### BACKGROUND

Quantifying financial risk and uncertainty associated with decision-making, on an event happening in the near future, is an ongoing challenge in financial assets management industry. Conventional approaches or solutions rely on one or two analytics areas, such as fundamental analysis and/or technical analysis. Analytical techniques may include artificial intelligence (AI) and/or traditional risk management solutions. However, conventional solutions, such as AI or any of the traditional risk management solutions, are not capable of providing real solutions to risk management problems. For example, conventional solutions do not take into account of the fact that there are numerous sources of risks and that risks vary not only due to different types of data but also over time due to technological and scientific advances.

Accordingly, there is a need for a risk management solution which accurately determines financial risks.

### SUMMARY

Embodiments of the present disclosure generally relate to an integrated trading assistant framework, which includes advanced mathematical modelling, artificial intelligence, machine learning, and deep learning, as well as use of existing trading instruments as a series of leverage tools in order to quantify and manage the risk in the prediction of the asset price action and trends of different asset classes and charts.

In one embodiment, an integrated trading framework which includes a real-time integrated and intelligent quantitative risk measurements, assessment, ranking and management framework is described. The framework may be used for financial trading instruments, single and diversified portfolios and single and multi-cross assets.

In another embodiment, an integrated trading framework which includes a deep learning of financial big data and sentiment analysis for assets selection, trading and portfolio optimization is disclosed.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure. In the following description, various embodiments of the present disclosure are described with reference to the following drawings, in which:

FIG. 1 shows an exemplary embodiment of the architect of an integrated trading framework;

FIG. 2 shows an exemplary method of an integrated trading framework;

FIG. 3 shows an exemplary user interface;

FIG. 4 shows an exemplary architecture of a stock selection module;

FIG. 5 shows an exemplary investment matrix of opportunities;

FIGS. 6a and 6b show examples of Sentiment analysis using different signals;

FIG. 7 shows an exemplary deep learning architecture for stock prediction; and

FIG. 8 show different examples of future predictions for different time frames.

### DETAILED DESCRIPTION

A computer-implemented integrated framework is described herein. The framework is an integrated robust, quantitative, informative and intelligent solution which aims to solve an important technical problem through a multi-disciplinary approach by providing an integrated solution. The main approach in the framework is to translate sentiment measurements of buyers and sellers into numbers in order to provide a complementary analysis to quantitative models. This approach makes the decision-making process for single trading and financial portfolio investment more robust while reducing risk of human error or misinterpretation of data.

In order to win every trade in the financial market, users need to have a powerful edge against the competition which provides informative knowledge in order to make informed decisions under market and price uncertainty. The notion of market risk and psychology (e.g. sentiment) is sometimes vague and that investors and traders may have an insensible outlook towards the risk imposed on their uncertain decision making process.

The present framework is an intelligent trading and real-time risk management solution. The framework may be implemented as a software running on a computer. The framework may be cloud based or reside on local computer. The framework helps individuals to make informed decisions and to make a move when the timing for entry and exit is right on an asset of choice, or assets which the framework intelligently selects based on its AI engine and user risk criteria to trade.

The framework reduces the uncertainty of investment or trading decision making by measuring the sentiment (e.g. psychology) of the markets as well as behavior of buyers and sellers and translates it into probabilities of edge versus odds. It verifies the way predictive model is showing the direction of the price action as the order size on bid (e.g. buy) and ask (e.g. sell) price and volume change. Level II (e.g. tick data or the price and size of buying and selling orders) market data may help to understand the behaviour of the price since the force behind the price movement is psychology changes of buyers and sellers.

The integrated quant (i.e. quantitative) trading framework aims to minimize the uncertainty of every single trade decisions and quantify the risk in the form of probability within a range of 1% to 99% win or loss and/or as the entry and exit signals in and out of the market, respectively. Market-timing is the major risk that is managed through this approach.

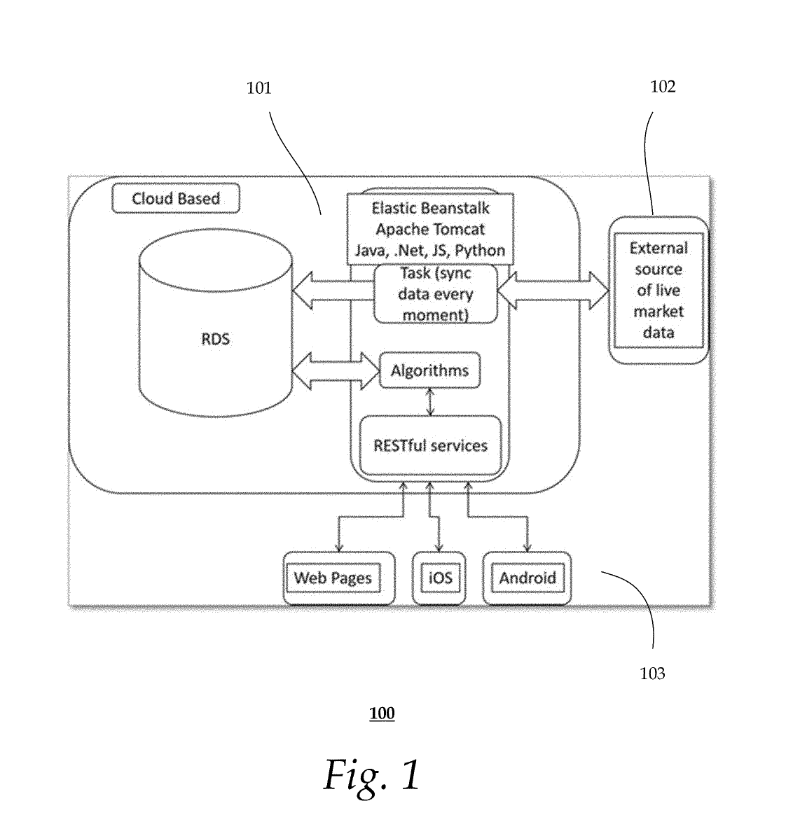

FIG. 1 shows an embodiment of a backend and server infrastructure of the framework 100. The architecture includes software components. The software components, for example, may include software applications, application modules and/or sub-modules that may be executed using one or more processors. The market data 102 is received from the server side 101 of the exchange and/or market data provider, and acts as an input to the server side, which is a cloud-based solution. The data is analyzed and the algorithms are applied to give an output for display on the user-end side 103.

In one embodiment, an end-user device is connected to the system. The end-user selects a real-time assets trading event. Real-time quantifiable assets assessment data feed are delivered from the system to the end-user device. The risk associated with each of these events is ranked and a probability number in percentage is assigned to each decision making on each single trade.

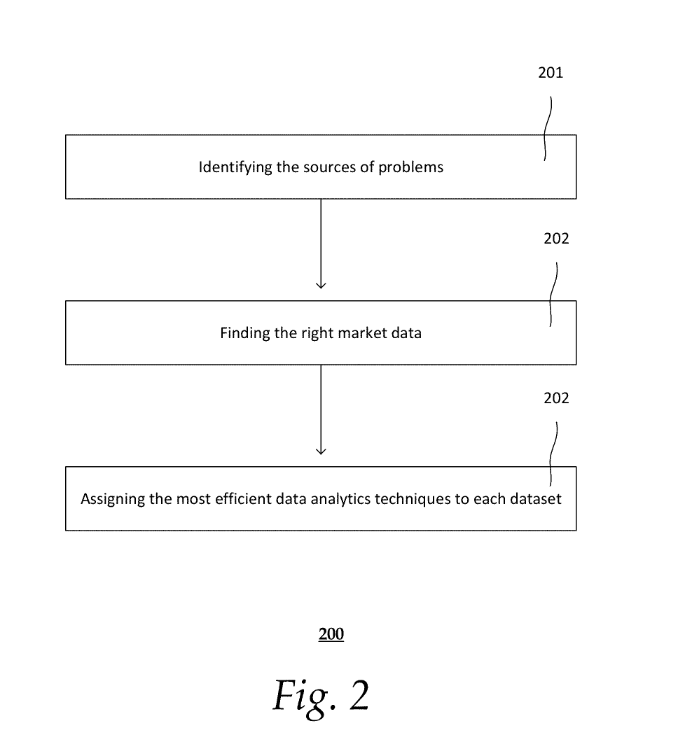

FIG. 2 shows an exemplary method of an integrated trading process. A general framework includes identifying the sources of problems, finding the right market data, and assigning the most efficient data analytics techniques to each dataset are steps of a general framework. The process is capable of assessing financial risks. The process, for example, may be performed by the exemplary system described in FIG. 1. Providing other systems may also be useful.

At step 201, the sources of risks every trader and investor is dealing with are defined in a quantitative fashion. The sources of risks are then being modelled.

The real-time and intelligent risk source identification, assessment, and management, may be imposed by different events on the price of an asset. These events can be news, financial and economic reports, companies' earnings, major and minor natural and man-made disasters and events, sentiment and psychology change of the market, firms, and big investors in a quantifiable application. The risk associated with each of these events is ranked and a probability number in percentage is assigned to each decision making process on each single trade.

At step 202, the right datasets serving specific problem are found. Cross correlation of a chart or an asset compared to the other assets may be found. The dependency of an asset price with respect to any other assets or stocks, markets, indices prices, and or markets sentiments may also be identified. This ranks all the important factors affecting price of a single trade or asset, a portfolio, and asset in real-time, based on a weighting system. This weighting and factors list can change on daily basis.

At step 203, the right analytics such as mathematical models, machine learning techniques as well as trading and portfolio management techniques are applied in this framework to solve the market and investment risk complex problem. Highly accurate entry and exit, and or buy, hold or sell signals may be provided through a combination of quantitative and sentiment analytical approach to constrain the risk and uncertainty in decision making associated with entering a trade or market, and exit out of it. The approach is multi-dimensional and incorporates a few parameters into calculation and consideration, such as memory of the price action, stability of a real-time analysis, fast computational speed, cloud computational analysis, big data and deep learning algorithms, to find the patterns and anomalous behaviours in both price, volume and sentiment of the market or assets.

This framework implements several algorithms to quantify the uncertainty in the predictions of future assets values, and provides to the user important hints and advice to optimize entries and exits in a semi-automatic mode. The framework also has the capability of performing automatic trading once the personal risk profile of the trader has been defined.

In an example, the frame provides analysis in real time. User optimum entrance and exit signals are provided. Optimal investment decisions are achieved by maximizing the number of right decisions and minimizing the number of wrong decisions. Maximizing the number of right decisions and minimizing the number of wrong decisions may be based on the amount loss of capital induced by a wrong (precipitated) entrance.

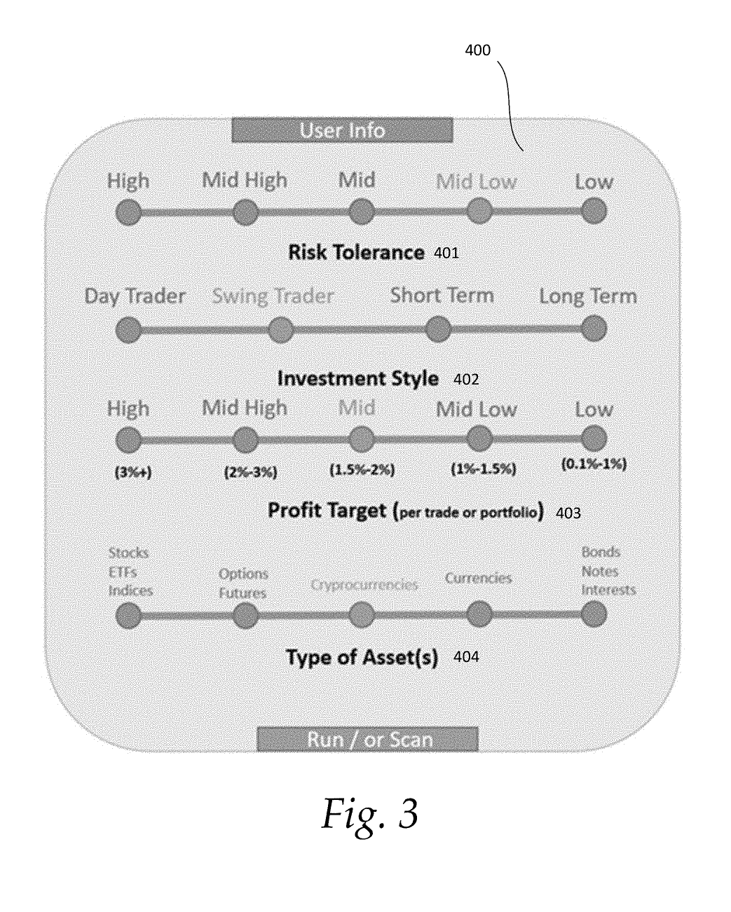

FIG. 3 shows an example of the user information panel 400 for the analysis in real time. The method includes several original modules that serve to adapt the trading style to a simple parameterization of the user information: 1. Risk tolerance 401; 2. Investment style 402; 3. Profit target 403; and 4. Type of Asset 404. Among these parameters there are existing trade-offs that the method will establish. Other parameters may also be useful.

A user may customize investment and trading opportunities and find them based on personal preferences, risk tolerance, and expectations via the user interface. This module is also able to be applied to certain asset classes or markets, domestically and internationally. For example, user may choose US Stock market, or commodity or derivative markets of Europe, and vice versa.

The method provides the daily analysis of the optimum targets depending on the historical information and the user profile. The method gives to the user the following information, which is the result of the analysis in the back-end analytical framework: (1) The 10 most interesting assets; (2) The optimum time frame to monitor the stock global trend (long or short); (3) The estimated risk and target benefits together with the suggested stops; and (4) Based on these pieces of information approved (and/or modified) by the user, the framework provides to the user the optimum entrance and exit signals.

The method also filters out and ranks the best trading and investment opportunities based on user's customizations from least risky to high risky assets, and for cryptocurrencies. The same concept may be applied to other asset classes. User defines the following input parameters qualitatively and/or quantitatively, then the automated A.I. engine starts searching and matching investment (i.e. trading) opportunities in the asset class or a few asset classes of choice:
1. What is your (user's) risk tolerance? (e.g., High, Mid High, Mid, Mid Low, Low)
2. What is your (user's) investment style?
   a. Day trader (e.g. buy and sell intraday),
   b. Swing trader (e.g. a few days holding time period),
   c. Short-term investor (e.g. from a couple of weeks to less than a year investment position holder),
   d. Long-term investors (e.g. 1 year and above holding time window).
3. What is your (user's) expected returns? High, Mid High, Mid, Mid Low, Low.
4. What is your (user's) asset of interests? Cryptocurrencies, Stocks, ETFs, Indices, Bonds, Notes, Options, Futures, Commodities, Interest Rates, etc.

In this framework, the main question to answer is what to invest or trade on. User may set up those customized parameters and receives existing opportunities based on the risk that each asset imposes. Also, each asset has different characteristics to be a part of portfolio. If and when user decides to build a mid to long term investment portfolios, variety of options are available. For example, if a portfolio is risk averse or conservative buy and hold, it implies that user should choose a series of opportunities and add them based on the risk they impose to the entire portfolio. Options such as defensive opportunities, hedging opportunities, or alternative investments, or ETFs, and/or even emerging market opportunities for investment also are ranked based on the risk they impose and are available in front of investors to add to their shopping cart and basket of portfolio.

Sentiment measurement of each selected asset as well as the risk it imposed also a part of this analytical tool which is a separate measurement. It plays a role in overall risk exposure on each asset and/or portfolio. Best to worst risk-based investment opportunities are ranked and selected based on markets, industries, sectors, and countries and are at users' disposal. The selection process of each of these markets, industries, etc. are on users to decide.

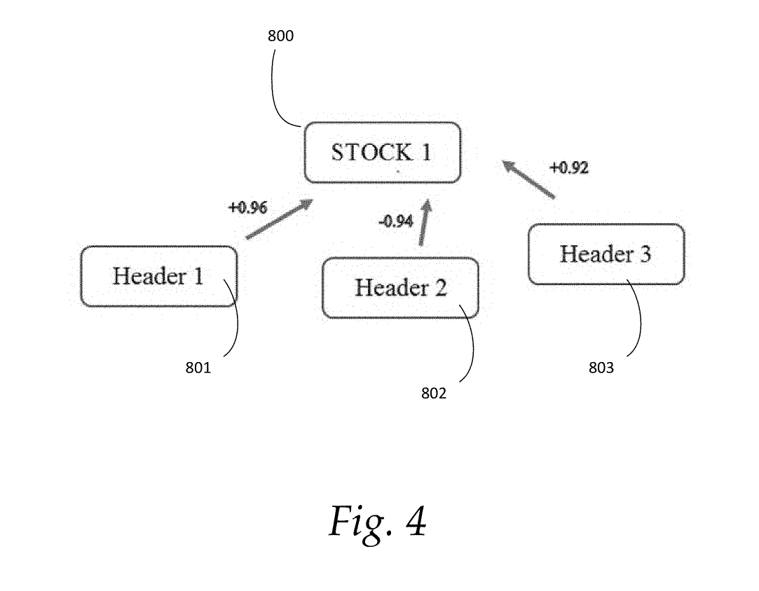

FIG. 4 shows an exemplary architecture of a stock selection module. The architecture illustrates how a stock is correlated to 3 stock headers in a typical time, length, and frame. The correlation tree for a given stock may be provided based on Kruskal's algorithm. Other algorithm may also be useful. For example, FIG. 4 shows the relationship between the selected stock 1 800 with the 3 most correlated headers 801/802/803 with both positively and negatively correlations. In this case, two stocks 801/803 are positively correlated and one stock 802 exhibits a negative correlation.

The method establishes for the selected asset the mostly correlated assets in the selected time-frame, positively and negatively. For that purpose, the method uses different measures of dependency in a typical time length that it can be automatically established based on mathematical modelling of time series. This information can be shown as a graph in a dependency tree (minimum spanning tree) by finding the header stocks that exhibit the biggest correlation with the target. The method uses different kind of correlations (Pearson, Sperman's rank correlation, Mutual information, etc.) to establish the existing dependencies among stocks. These correlations will serve to establish confirmations about the entrance/exit signals. Based on this analysis, the method provides the matrix of investment opportunities.

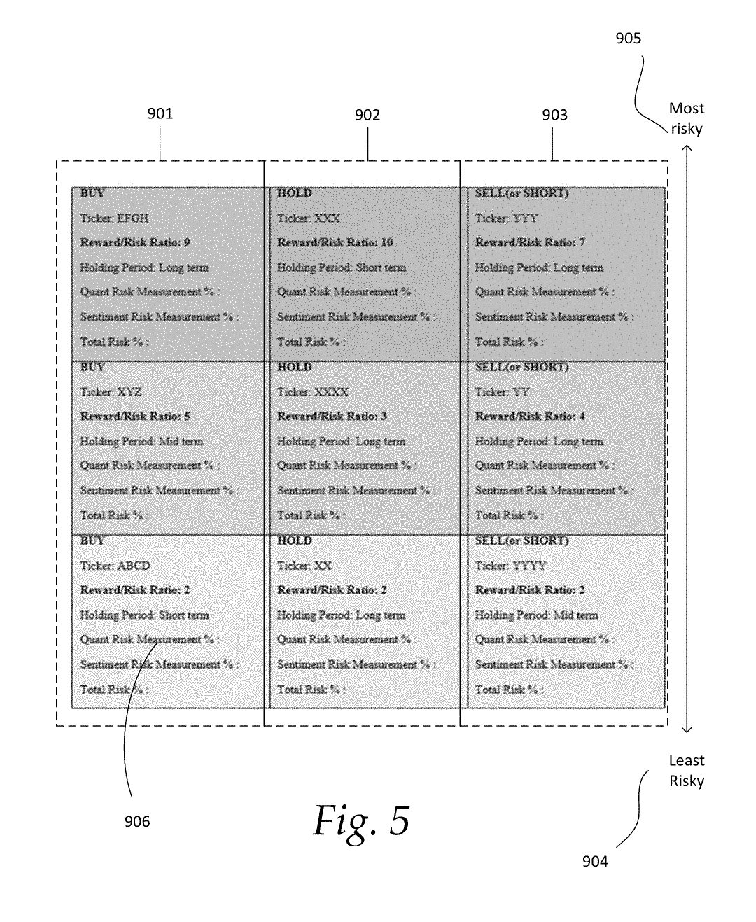

FIG. 5 shows an exemplary matrix of investment opportunities for stock selection based on the analysis method.

The matrix shows how opportunities may be ranked based on buy 901, sell 903 and hold 902, horizontally as well as their risk ranking from least risky 904 to most risk 905 vertically. The table may be sorted out or ranked based on any parameter of choice 906, such as reward to risk ratio, holding period, risk %, timeframe, etc. Table may be colour coded based on the strength for BUY, SELL, and HOLD as well. For example, below vertical columns for BUY, HOLD, and SELL or SHORT, opportunities are ranked based on Reward to Risk ratio. It may be ranked and sorted based on any other parameter of choice by user, listed in the table. A small graph may be also displayed in each square of the table which is representative of the corresponding symbol. The matrix also shows the optimum time frame to monitor the stock and also to produce the entrance and exit signals dynamically.

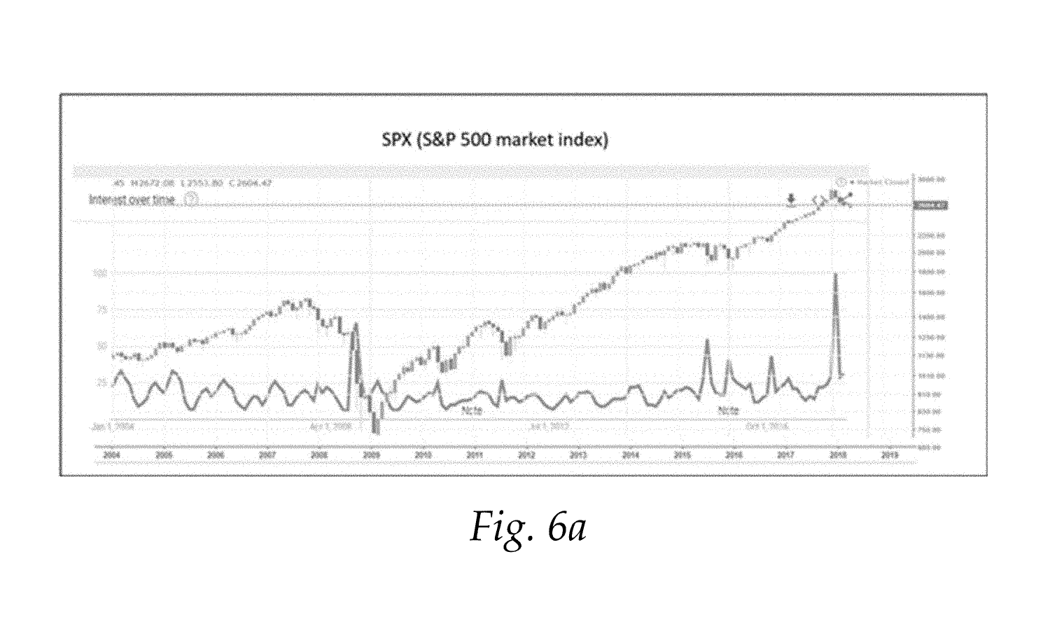

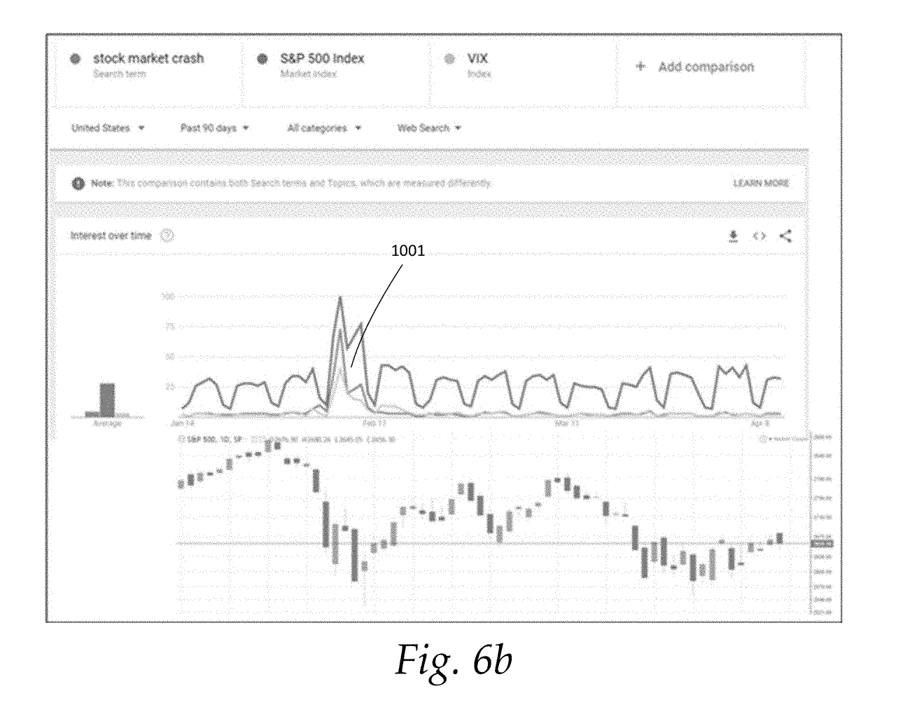

Referring to FIGS. 6a-6b, Sentiment analysis may use different signals from social networks and other economic indicators. Sentiment analysis will be also used to confirm these signals. Multiple correlations to different kind of signals will be established and dynamically updated. These signals might come from social networks and/or different economic indicators that may be weakly correlated to the target, which might be sampled at a different rate than the corresponding target. The sentiment analysis signals might be also delayed with respect to the optimum entrance and exit signals provided by the values of the stock, the volume information and the bid and ask. A machine learning methodology will be implemented to take into account and correct this delay.

FIG. 6a depicts the overlapped S&P 500 monthly price chart on sentiment measurements curve for the following keyword “stock market crash” from 2004 to present. Sentiment measurements in this graph is a normalized number of times that the keyword is searched and/or repeated in financial news, reports, and other alternative sources of data on the web. Sentiment graph based on financial, and fundamental variables of an asset or news from decision making agencies have a big impact on the reaction of users and investors on a particular asset or on the market as a whole. These reports are Federal Reserves, European Central Bank, IMF, etc. reports and updates on economical fundamental changes such as unemployment or inflation, deflation etc. or reports from companies to tax and regulatory agencies bodies such as SEC, FINRA, etc. Also pending litigations, management changes, board decisions, executive team's shares buying or sell outs would affect the price of an asset. Moreover, the sentiment of analytics from different institutions and their reports and analysis on upgrading, or downgrading certain assets such as stocks would also affect the sentiment and behaviour of the investors over certain assets, sectors, or industries.

The method also learns using machine learning and optimization techniques which are the optimum attributes that confirm the optimum entrance and exit signals. This analysis includes, but it is not limited to, global optimization algorithms such as Particle Swarm Optimization, Genetic algorithms, Technical Analysis Descriptors, Neural Networks, Deep Learning Techniques, Model Reduction and Feature Selection Techniques. In one embodiment, Long Short Term Memory (LSTM) neural networks may be used because that is very adequate to stock prediction.

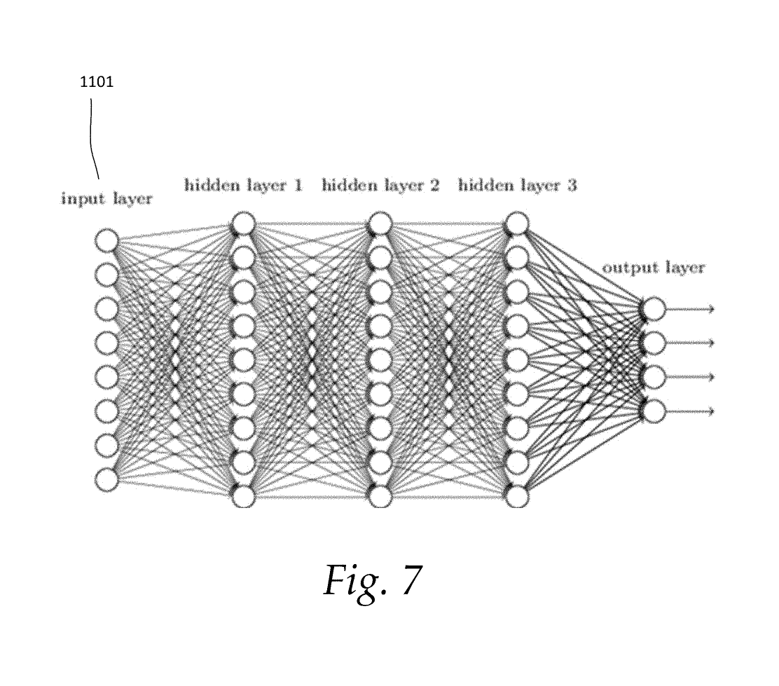

FIG. 7 shows an exemplary deep learning architecture for stock prediction. Machine learning techniques, deep learning, and convolved neural network models (CNNs), model reduction techniques and global optimization may be used to design neural networks to establish optimum architectures and perform future values of predictions. The input layer 1101 will be based on price information, different technical descriptors, volume, bid and ask sentiment analysis, etc. The Neural Network will predict the future value, the trend, and other interesting features that will be the result of the output layer. The architecture will be optimized using Particle Swarm Optimization that will serve to explore the space of equivalent architectures. The final decision will be made by majority voting.

All the decisions are given with its corresponding uncertainty assessment. The method will give entrance and exit signal for long and short trading taking into account the information and profile given by the user. Sometimes the signals might not be optimum since the user is given very conservatory risk tolerance and benefit target information. Nevertheless, the last decision is always user-based (semi-automatic mode).

The method also has the option of the automatic mode to trade the selected stocks without the user decision. This automatic mode has the advantage of avoiding fear and greed, since it is based in purely quantitative analysis.

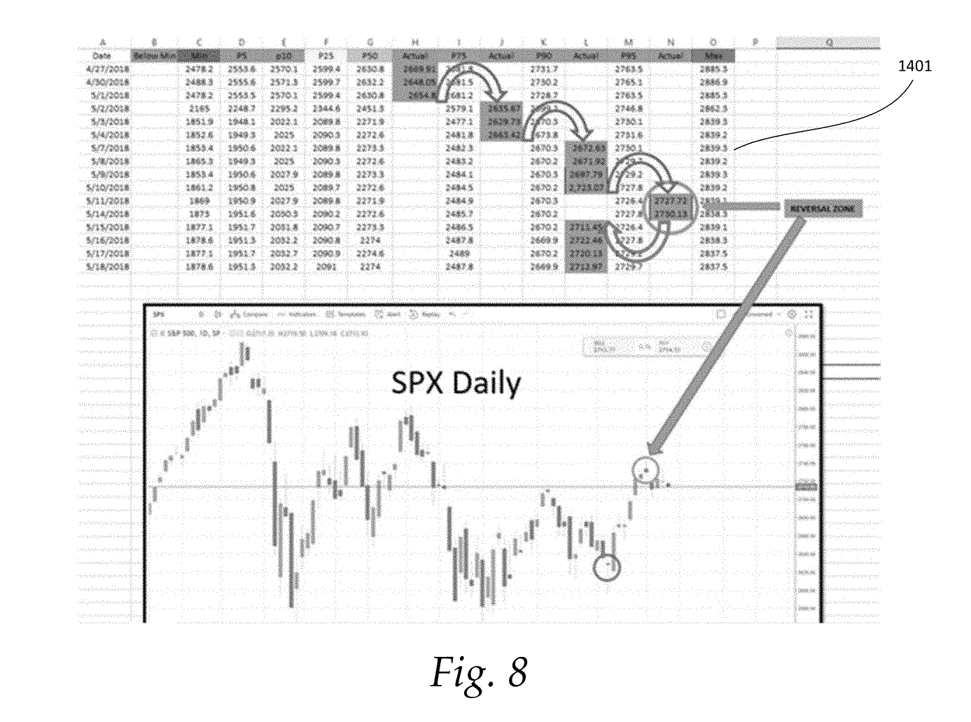

Future predictions may be provided in different time frames (minutes, days or weeks). For example, as shown in FIG. 8, future prediction for 16 weeks for SP500 is illustrated. In this case, the CDFs are shown in a matrix 1401 and the new stocks values switch on different cells of the prediction matrix

Different sources of data, such as supply and demand function and behaviors, news, reports and events, would affect every single asset's behavior in different markets. These factors create market volatility and uncertainty at any moment in time. These data and behavior impose uncertainty in investment decision making processes. The framework aims to resolve uncertain sources of information which impose risk on every single trade, portfolio and/or asset executed by the end-users, domestically within the US and/or globally. The comprehensive and easy-to-use quant framework also helps in managing risks for globally allocated portfolios and assets. The framework is able to identify, assess and manage risk in a single trade to big scale assets intelligently and provide real-time analytics for end-users to minimize the risk of entering and exiting a trade, market, and/or an asset.

The intelligent trading and risk management framework are able to provide accurate signaling for entry and exit, during buying and/or selling of low volatility to very high volatility assets. The framework, based on intelligent analytics, also provides a zone in order to buy or sell assets which would help in mitigating execution as well as timing risk. The end-user may or may not miss an opportunity to make a decision at a point in time, but in this zone the end-user is provided time for making a decision to buy or sell, without the feeling of missing out which may typically result in the end-user chasing a price action. The framework enables the end-user to avoid chasing a price action which is usually one of the main factors and reasons for making wrong decisions and mistakes.

Screening of investment and trading opportunities are the essential parts of the method. Combined quantitative models based as well as sentiment measurements are the backbone of finding the best opportunities and risk ranking system of the method. Key modules of the method include a cutting-edge revolutionary trading framework to achieve optimal investment decisions. Disruption at its core, the method helps users in order to maximize the number of right decisions (e.g. profit) with very high accuracy (more than 90%), minimizing the number of wrong decisions (e.g. amount of loss of capital).

The framework provides a Risk Optimal Decision Making methodology for financial instruments based on different modules: 1) A.I based risk ranking system in real time; 2) Uncertainty bands and Predictive Analysis; 3) Big data and Sentiment Analysis; and 4) Intelligent Portfolio selection and optimization. The method uses an in-house Optimal Investment Stocks Finder, based on the user information: risk tolerance, investment style, profit target and type of preferred asset. The method will establish the optimal entrance and exit signals for the selected asset. Further, this framework can work in semi-automatic and automatic mode, without any input from the user.

Measuring heartbeat for many people, and in a bigger scale of population would also give an indicator of how a crowd behavior, risk, fear, greed would react to the market and vice versa. This would be a very powerful measure in terms of how the crowd is affected by market price action and behavior and how market is affected by a big number of traders whom their body signals are measured and analyzed in real-time versus the market.

Wearables of all sorts may be provided for this integrated trading and risk management framework. The wearables are adaptable to be paired to the integrated trading and risk management framework, e.g. via an app, to make the following measurements a reality: Heartbeat in BPM, Blood Pressure, EKG, EEG, EMG, etc.

Furthermore, a hat may be provided for this integrated trading and risk management framework. AR/VR through hat is going to bring everything in user's fingertips and eyes, through its hat. The hat is able to wirelessly communicate and analyze market data, user data, and any other sort of relevant data types which are going to be used through the process.

What is claimed is:

1. A method for trading and risk management, the method comprising:
identifying quantitative and sentimental parameters of trading market;
analyzing the quantitative and sentimental parameters of the trading market;
providing a stock selection module to perform future predictions based on the analyzed quantitative and sentimental parameters, wherein the stock selection module comprises a deep learning architecture;
providing a probability number in percentage to a trading decision; and
providing entrance and exit signals to a user based on user preferences.

2. A non-transitory computer readable medium embodying a program of instructions executable by a machine to perform operations for trading and risk management, the operations comprising:
identifying quantitative and sentimental parameters of trading market;
analyzing the quantitative and sentimental parameters of the trading market;
providing a stock selection module to perform future predictions based on the analyzed quantitative and sentimental parameters, wherein the stock selection module comprises a deep learning architecture;
providing a probability number in percentage to a trading decision; and
providing entrance and exit signals to a user based on user preferences.

3. A method for trading and risk management, the method comprising:
combining bio-signals and natural responses of a user to control and verify individuals decision making and to customize the tools and analytics based on the user's trading preferences, risk tolerance, expectations, and trading appetite, wherein the biosignals and natural responses of the user includes heartbeat data in real-time, blood pressure, and brain signal, including EEG and EMG data as well as EKG data from heart.

4. The method of claim 3 wherein the combining bio-signals and natural responses of the user comprises using algorithms find the correlation of the user's body responses to these signals and recordings and compare them with the stock market behavior and stock of choice the user select to trade in order to adjust the right risk and return and trading strategies to the user.

4. The method of claim 3 wherein the combining bio-signals and natural responses of the user comprises measuring heartbeat for many people, and in a bigger scale of population would also give an indicator of how a crowd behavior, risk, fear, greed would react to the market; and analyzing the signals in real-time.

5. The method of claim 3 wherein the combining bio-signals and natural responses of the user comprises providing wearables that are adaptable to be paired to the trading and risk management framework to measure heartbeat in BPM, blood pressure, EKG, EEG, or EMG.

6. The method of claim 3 wherein the combining bio-signals and natural responses of the user comprises providing an AR/VR trading hat is going to bring everything in the user's fingertips and eyes, wherein the hat is configured to wirelessly communicate and analyze market data and user data.
